(19) United States
(12) Patent Application Publication
(10) Pub. No.: US 2021/0319538 A1
(43) Pub. Date: Oct. 14, 2021

(54) IMAGE PROCESSING METHOD AND DEVICE, ELECTRONIC EQUIPMENT AND STORAGE MEDIUM

(71) Applicant: SHENZHEN SENSETIME TECHNOLOGY CO., LTD., Shenzhen (CN)

(72) Inventors: Shangchen ZHOU, Shenzhen (CN); Jiawei ZHANG, Shenzhen (CN); Sijie REN, Shenzhen (CN)

(21) Appl. No.: 17/345,042

(22) Filed: Jun. 11, 2021

Related U.S. Application Data
(63) Continuation of application No. PCT/CN2019/113749, filed on Oct. 28, 2019.

(30) Foreign Application Priority Data
Jan. 22, 2019 (CN) 201910060238.6

(51) Int. Cl. G06T 5/00; G06T 7/593; G06T 5/50

(52) U.S. Cl. CPC G06T 5/003; G06T 7/593; G06T 2207/10012; G06T 2207/20221; G06T 5/50

(57) ABSTRACT

An image processing method and device, an electronic equipment and a storage medium are provided. The method includes: acquiring a binocular image, the binocular image comprising a first image and a second image photographed in the same scene for the same object; acquiring a first feature image of the binocular image, a first depth image of the binocular image, and a second feature image fusing image features and depth features of the binocular image; performing a feature fusion procession on the binocular image, the first feature image of the binocular image, the first depth image and the second feature image, to obtain a fusion feature image of the binocular image; and optimizing the fusion feature image of the binocular image to obtain a deblurred binocular image.

### CROSS-REFERENCE TO RELATED APPLICATION

The present application is a U.S. continuation application of International Application No. PCT/CN2019/113749, filed on Oct. 28, 2019, which is filed based upon and claims priority to Chinese Patent Application No. 201910060238.6, filed on Jan. 22, 2019. The disclosures of International Application No. PCT/CN2019/113749 and Chinese Patent Application No. 201910060238.6 are hereby incorporated by reference in their entireties.

### BACKGROUND

At present, binocular vision is rapidly developed in the fields of smart phones, manless driving, unmanned aerial vehicles, robots and the like. Binocular cameras are now ubiquitous, and binocular-image-based related topic researches are also further developed and, for example, applied to the fields of stereo matching, binocular image super-resolution processing, binocular style transfer and the like. However, there may usually be such a condition in application that an image is blurry due to factors such as camera jitter, defocusing and high-speed movement of an object. For this condition, few achievements are made in the field of binocular deblurring, and optimized methods are unsatisfactory in performance and efficiency.

### SUMMARY

The disclosure relates, but not limited, to the field of image processing, and particularly to an image processing method and device for binocular images, an electronic device and a storage medium.

Embodiments of the disclosure provide an image processing method and device, an electronic device and a storage medium, for improving the accuracy of binocular images.

According to an aspect of the disclosure, an image processing method is provided, which may include that: binocular images are acquired, the binocular images including a first image and second image which are shot for the same object in the same scenario; first feature maps of the binocular images, first depth maps of the binocular images and second feature maps fusing an image feature and depth feature of the binocular images are obtained; feature fusion processing is performed on the binocular images, the first feature maps of the binocular images, the first depth maps of the binocular images and the second feature maps to obtain fused feature maps of the binocular images; and optimization processing is performed on the fused feature maps of the binocular images to obtain deblurred binocular images.

According to a second aspect of the disclosure, an image processing device is provided, which may include: an acquisition module, configured to acquire binocular images, the binocular images including a first image and second image which are shot for the same object in the same scenario; a feature extraction module, configured to obtain first feature maps of the binocular images, first depth maps of the binocular images and second feature maps fusing an image feature and depth feature of the binocular images; a feature fusion module, configured to perform feature fusion processing on the binocular images, the first feature maps of the binocular images, the first depth maps of the binocular images and the second feature maps to obtain fused feature maps of the binocular images; and an optimization module, configured to perform optimization processing on the fused feature maps of the binocular images to obtain deblurred binocular images.

According to a third aspect of the disclosure, an electronic device is provided, which may include a processor and a memory configured to store instructions executable for the processor, the processor being configured to execute any method in the first aspect.

According to a fourth aspect of the disclosure, a computer-readable storage medium is provided, in which computer program instructions may be stored, the computer program instructions being executed by a processor to implement any method in the first aspect.

According to a fifth aspect of the disclosure, a computer program product is provided, which may include computer program instructions, the computer program instructions being executed by a processor to implement any method in the first aspect.

### BRIEF DESCRIPTION OF THE DRAWINGS

The accompanying drawings, which are incorporated in and constitute a part of this specification, illustrate embodiments consistent with the disclosure and, together with the specification, serve to describe the technical solutions of the disclosure.

FIG. 1 is a flowchart of an image processing method according to embodiments of the disclosure.

FIG. 2 is a flowchart of S20 in an image processing method according to embodiments of the disclosure.

FIG. 3 is a block diagram of neural network model for implementing an image processing method according to embodiments of the disclosure.

FIG. 4 is a structure block diagram of a context-aware unit according to embodiments of the disclosure.

FIG. 5 is a flowchart of S23 in an image processing method according to embodiments of the disclosure.

FIG. 6 is another flowchart of S20 in an image processing method according to embodiments of the disclosure.

FIG. 7 is a flowchart of S30 in an image processing method according to embodiments of the disclosure.

FIG. 8 is a block diagram of a fusion network module according to embodiments of the disclosure.

FIG. 9 is a flowchart of S31 in an image processing method according to embodiments of the disclosure.

FIG. 10 is a block diagram of an image processing device according to embodiments of the disclosure.

FIG. 11 is a block diagram of an electronic device 800 according to embodiments of the disclosure.

FIG. 12 is a block diagram of an electronic device 1900 according to embodiments of the disclosure.

### DETAILED DESCRIPTION

According to the embodiments of the disclosure, the binocular images is taken as an input, and feature extraction processing is performed on the first image and second image in the binocular images respectively to obtain corresponding first feature maps. Depth maps of the first image and second image in the binocular images may be obtained. Then, the obtained features may be fused to obtain a fused feature including view information and depth information. The fused feature includes richer picture information and is higher in robustness to space-variant blur. Finally, optimization processing is performed on the fused feature to obtain clear binocular images. In the embodiments of the disclosure, deblurring processing is performed on the binocular images, and the accuracy and resolution of the image are improved. It is to be understood that the above general description and the following detailed description are only exemplary and explanatory and not intended to limit the disclosure. According to the following detailed descriptions made to exemplary embodiments with reference to the drawings, other features and aspects of the disclosure may become clear.

Each exemplary embodiment, feature and aspect of the disclosure will be described below with reference to the drawings in detail. The same reference signs in the drawings represent components with the same or similar functions. Although each aspect of the embodiments is shown in the drawings, the drawings are not required to be drawn to scale, unless otherwise specified.

Herein, special term “exemplary” refers to “use as an example, embodiment or description”. Herein, any “exemplarily” described embodiment may not be explained to be superior to or better than other embodiments.

In the disclosure, term “and/or” is only an association relationship describing associated objects and represents that three relationships may exist. For example, A and/or B may represent three conditions: i.e., independent existence of A, existence of both A and B and independent existence of B. In addition, term “at least one” in the disclosure represents any one of multiple or any combination of at least two of multiple. For example, including at least one of A, B and C may represent including any one or more elements selected from a set formed by A, B and C.

In addition, for describing the disclosure better, many specific details are presented in the following specific implementation modes. It is understood by those skilled in the art that the disclosure may still be implemented even without some specific details. In some examples, methods, means, components and circuits known very well to those skilled in the art are not described in detail, to highlight the subject of the disclosure.

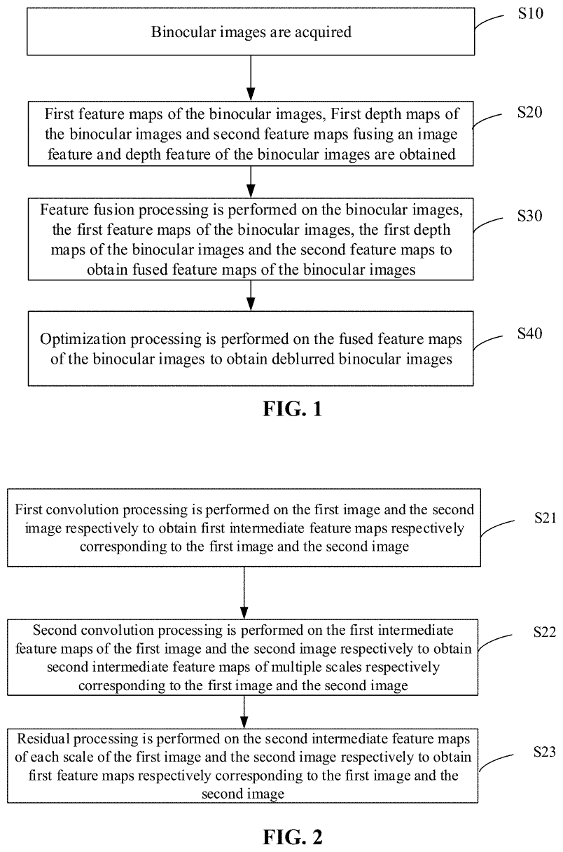

FIG. 1 is a flowchart of an image processing method according to an embodiment of the disclosure. The image processing method of the embodiment of the disclosure may be used for performing deblurring processing on binocular images to obtain clear binocular images. The method of the embodiment of the disclosure may be applied to a binocular camera, a binocular photographic device, an air vehicle or another device with a photographic function, or the embodiment of the disclosure may also be applied to an electronic device or server device with an image processing function, for example, a mobile phone and a computer device. No specific limits are made thereto in the disclosure. The embodiment of the disclosure may be applied if a binocular photographing operation may be executed or the image processing function may be executed. The embodiment of the disclosure will be described below in combination with FIG. 1.

As shown in FIG. 1, the image processing method of the embodiments of the disclosure may include the following operations. In S10, binocular images are acquired, the binocular images including a first image and second image which are shot for the same object in the same scenario.

As mentioned above, the method of the embodiments of the disclosure may be applied to a photographic device or an image processing device, and the binocular images may be acquired through the above device. For example, the binocular images are collected through the photographic device or transmitted through another device. The binocular images may include the first image and the second image. In a practical application process, there may be such a condition that an image is blurry or relatively low in resolution due to various factors for the photographic device collecting a binocular view that (for example, conditions of device jitter and movement of the shot object). In the embodiments of the disclosure, deblurring processing may be performed on the binocular images to obtain clear binocular images. According to different structural conditions of the photographic device, the first image and second image in the binocular images may be constructed to a left-side image and a right-side image respectively, or may also be constructed to an upper-side view and a lower-side view. This may specifically be determined according to a position of a camera lens of the photographic device collecting the binocular images. No specific limits are made thereto in the embodiments of the disclosure.

In S20, first feature maps of the binocular images, first depth maps of the binocular images and second feature maps fusing an image feature and depth feature of the binocular images are obtained.

In some embodiments, the binocular images may be images collected for the same object at different angles at the same moment. Therefore, a depth value of the object may be determined in combination with a viewing angle difference of the binocular images. For example, a binocular camera is used to simulate eyes of a person to collect images of an object from different angles respectively, and two images collected by the camera at the same moment may form binocular images. After the binocular images are obtained, a feature map and depth map in the binocular images and a feature map fusing feature information and depth information may be extracted.

According to the embodiments of the disclosure, a feature extraction function may be realized through a neural network. For example, the neural network may be a convolutional neural network. First feature maps and first depth maps of the first image and the second image are extracted through the neural network respectively. The neural network may include an image feature extraction module and a depth feature extraction module. The binocular images may be input to the image feature extraction module to obtain the first feature map of the first image and the first feature map of the second image respectively. The binocular images may be input to the depth feature extraction module to obtain the first depth map of the first image and the first depth map of the second image. Meanwhile, a second feature map fusing an image feature and depth feature of the first image and a second feature map fusing an image feature and depth feature of the second image may also be acquired respectively. The first feature maps represent the image features of the first image and the second image, for example, information of a pixel value of each pixel. The first depth maps represent the depth features of the first image and the second image, for example, depth information of each pixel. The image features and the depth features are fused in the second feature maps. Moreover, the pixels of the first depth map, the pixels of the first feature map and the pixels of the second feature map correspond one to one.

Structures of the image feature extraction module and the depth feature extraction module are not specifically limited in the embodiments of the disclosure, may include structures such as a convolutional layer, a pooling layer, a residual module or a fully connected layer, and the like, and may be set by those skilled in the art as required, and any structure capable of implementing feature extraction may be considered as an embodiment of the disclosure. After all features are obtained, feature fusion processing may be performed to obtain a more accurate feature map on the basis of further fusing each piece of information.

In S30, feature fusion processing is performed on the binocular images, the first feature maps of the binocular images, the first depth maps of the binocular images and the second feature maps to obtain fused feature maps of the binocular images.

In some embodiments of the disclosure, feature fusion processing may be performed according to each feature obtained in S20, namely feature fusion processing may be performed on the original image and the corresponding first feature map, second feature map and first depth map, to obtain a fused feature. The fused feature may include richer picture information (image features) and is higher in robustness to space-variant blur.

For example, the neural network of the embodiments of the disclosure may include a fusion network module, and the fusion network module may execute S30. The first feature map, first depth map and second feature map of the first image may be input to the fusion network module to obtain a fused feature map, fusing image information and depth information of the first image, of the first image. Correspondingly, the first feature map, first depth map and second feature map of the second image may be input to the fusion network module to obtain a fused feature map, fusing image information and depth information of the second image, of the second image. A clearer optimized view may be obtained through the obtained fused feature map. A structure of the fusion network module is also not specifically limited in the embodiments of the disclosure, may include structures such as a convolutional layer, a pooling layer, a residual module or a fully connected layer, and the like, and may be set by those skilled in the art as required, and any structure capable of implementing feature fusion may be considered as an embodiment of the disclosure.

When the feature map and the depth map are fused, fusion may be implemented in a manner of feature concatenation after feature warp, or feature fusion may be implemented based on fusion calculation such as feature weighted averaging after feature warp. There are many feature fusion manners, and no further limits are made herein.

In S40, optimization processing is performed on the fused feature maps of the binocular images to obtain deblurred binocular images. In the embodiments of the disclosure, the first fused feature map and the second fused feature map may be optimized through a convolution processing operation. Through the convolution operation, a more accurate optimized view may be obtained by use of valid information in each fused feature map. Through the embodiments of the disclosure, deblurring of the binocular images may be implemented, and the resolution of the view may be improved.

The neural network of the embodiments of the disclosure may further include an optimization module. The first fused feature map of the first image and the first fused feature map of the second image may be input to the optimization module respectively, and the first fused feature maps of the two images may be fused and optimized respectively through at least one time of convolution processing operation of the optimization module. Scales of obtained optimized fused feature maps correspond to scales of the original binocular images, and the resolutions of the original binocular images are improved.

Each process will be described below in detail. As mentioned above, after the binocular images are obtained, feature extraction processing may be performed on the first image and second image in the binocular images respectively. FIG. 2 is a flowchart of S20 in an image processing method according to embodiments of the disclosure. The operation that the first feature map of the binocular images is obtained may include the following operations.

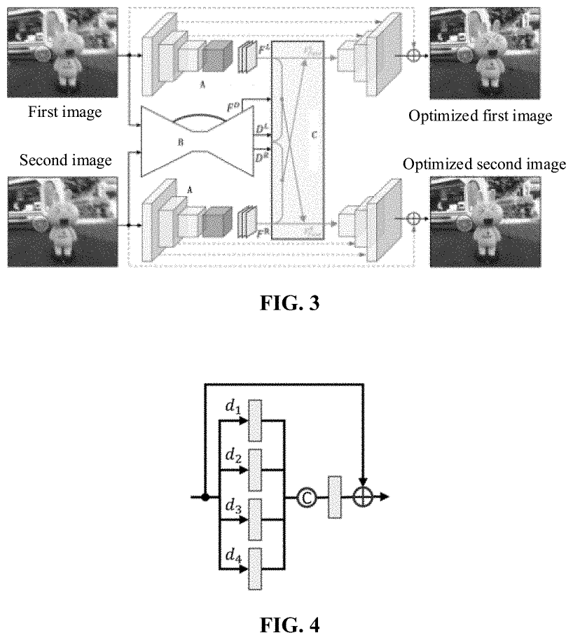

In S21, first convolution processing is performed on the first image and the second image respectively to obtain first intermediate feature maps respectively corresponding to the first image and the second image. In the embodiments of the disclosure, the neural network may include the image feature extraction module (deblurring network module), and S20 may be executed by use of the image feature extraction module to obtain the first feature maps of the binocular images. FIG. 3 is a block diagram of neural network model for implementing an image processing method according to embodiments of the disclosure. The binocular images may be input to the image feature extraction module A respectively to obtain the first feature map F^{L} of the first image according to the first image in the binocular images and obtain the first feature map F^{R} of the second image according to the second image.

Firstly, first convolution processing may be performed on the first image and the second image respectively. For the first convolution processing, corresponding convolution processing may be performed by use of at least one convolutional unit. For example, the first convolution operation may be executed sequentially by use of multiple convolutional units, an output of a previous convolutional unit being an input of a next convolutional unit. The first intermediate feature maps of the two images may be obtained through the first convolution processing, and the first intermediate feature map may include image feature information of the corresponding image. In the embodiment, first convolution processing may include standard convolution processing. The standard convolution processing is a convolution operation executed by use of a convolution kernel or a set convolution step, and each convolutional unit may execute convolution by use of a corresponding convolution kernel or execute convolution according to a preset step to finally obtain the first intermediate feature map representing the image feature information of the first image and the first intermediate feature map representing the image feature information of the second image. The convolution kernel may be a 1*1 convolution kernel and may also be a 3*3 convolution kernel, and those skilled in the art may select and set it as required. The convolution kernel adopted in the embodiments of the disclosure may be a small convolution kernel, so that the structure of the neural network may be simplified, and meanwhile, a requirement on the image processing accuracy may be met.

In S22, second convolution processing is performed on the first intermediate feature maps of the first image and the second image respectively to obtain second intermediate feature maps of multiple scales respectively corresponding to the first image and the second image.

In some embodiments of the disclosure, the feature extraction network module may include a context-aware unit, and after the first intermediate feature map is obtained, the first intermediate feature map may be input to the context-aware unit to obtain second intermediate feature maps of multiple scales.

The context-aware unit of the embodiments of the disclosure may perform second convolution processing on the first intermediate feature map of the first image and the first intermediate feature map of the second image to obtain the second intermediate feature maps of multiple different scales.

That is, after first convolution processing is performed, the obtained first intermediate feature map may be input to the context-aware unit, and the context-aware unit of the embodiments of the disclosure may perform second convolution processing on the first intermediate feature map. Through the process, second intermediate feature maps of multiple scales corresponding to the first intermediate feature map may be obtained without cyclic processing.

FIG. 4 is a structure block diagram of a context-aware unit according to embodiments of the disclosure. Further feature fusion and optimization processing may be performed on the first intermediate feature map of the first image and the first intermediate feature map of the second image through the context-aware unit respectively, and meanwhile, the second intermediate feature maps of different scales are obtained.

Second convolution processing may be atrous convolution processing. Atrous convolution may be executed on the first intermediate feature map by use of different atrous rates respectively to obtain second intermediate feature maps of corresponding scales. For example, in FIG. 4, second convolution processing is performed on the first intermediate feature map by use of four different first atrous rates d1, d2, d3 and d4 to obtain second intermediate feature maps of four different scales. For example, the scales of all second intermediate feature maps may have a changing relationship of double. No specific limits are made thereto in the disclosure. Those skilled in the art may select different first atrous rates according to requirements to execute corresponding second convolution to obtain corresponding second intermediate feature maps. In addition, the number of the atrous rates is also not specifically limited in the disclosure. The atrous rate for atrous convolution may also be called a dilated rate for atrous convolution. The atrous rate defines a distance between values when the convolution kernel processes data in atrous convolution.

According to the process, the second intermediate feature maps of the multiple scales corresponding to the first intermediate feature map of the first image may be obtained respectively, and the second intermediate feature maps of the multiple scales corresponding to the first intermediate feature map of the second image may be obtained respectively. The obtained second intermediate feature map may include feature information of the first intermediate feature map under different scales to facilitate a subsequent processing process.

In S23, residual processing is performed on the second intermediate feature maps of each scale of the first image and the second image respectively to obtain first feature maps respectively corresponding to the first image and the second image.

After the second intermediate feature maps of different scales corresponding to the first image and the second intermediate feature maps of different scales corresponding to the second image are obtained, residual processing may further be performed on the second intermediate feature maps of different scales through the context-aware unit to obtain the first feature map corresponding to the first image and the first feature map corresponding to the second image.

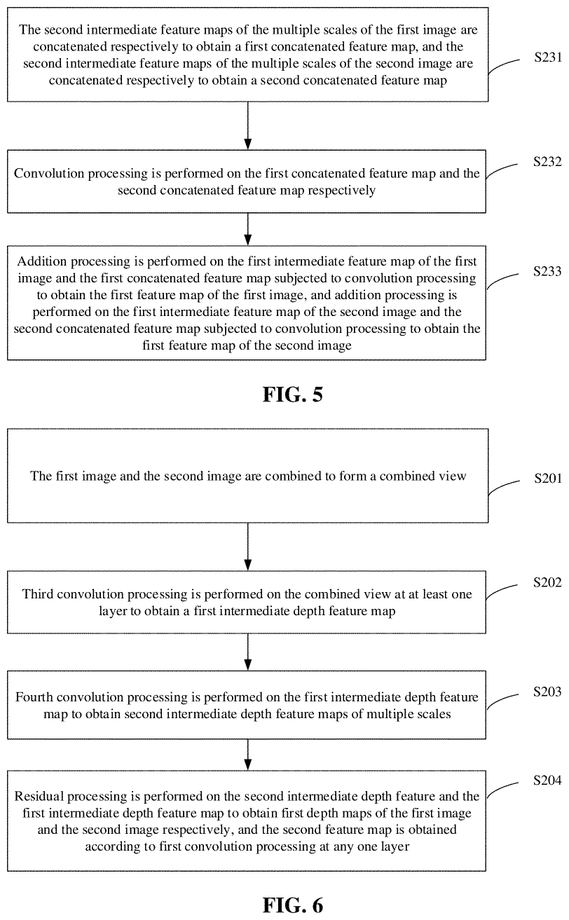

FIG. 5 is a flowchart of S23 in an image processing method according to embodiments of the disclosure. The operation that residual processing is performed on the second intermediate feature maps of each scale of the first image and the second image respectively to obtain the first feature maps respectively corresponding to the first image and the second image (S23) includes the following operations.

In S231, the second intermediate feature maps of the multiple scales of the first image are concatenated respectively to obtain a first concatenated feature map, and the second intermediate feature maps of the multiple scales of the second image are concatenated respectively to obtain a second concatenated feature map.

In some embodiments of the disclosure, after multiscale processing is performed on the first intermediate feature map, concatenation processing may further be performed on the obtained second intermediate feature maps of the multiple scales to obtain a corresponding feature map including information of different scales.

In some embodiments, concatenation processing may be performed on the second intermediate feature map of each scale of the first image to obtain the first concatenated feature map. For example, each second intermediate feature map is concatenated in a channel information direction. Meanwhile, concatenation processing may also be performed on the second intermediate feature maps of all scales of the second image to obtain the second concatenated feature map. For example, each second intermediate feature map is concatenated in the channel information direction. Therefore, features of the second intermediate feature maps of the first image and the second image may be fused.

In S232, convolution processing is performed on the first concatenated feature map and the second concatenated feature map respectively.

Based on a processing result of S231, convolution processing may be performed on the first concatenated feature map and the second concatenated feature map by use of the convolutional unit respectively. The features in each second intermediate feature map may further be fused through this process, and a scale of the concatenated feature map obtained by convolution processing is the same as the scale of the first intermediate feature map.

In some embodiments, the context-aware unit may further include a convolutional unit, configured for feature coding. The first concatenated feature map or second concatenated feature map obtained by concatenation processing may be input to the convolutional unit to execute corresponding convolution processing to implement feature fusion of the first concatenated feature map or the second concatenated feature map. Meanwhile, the first feature map obtained by convolution processing of the convolutional unit is matched with the first image in scale, and the second feature map obtained by convolution processing of the convolutional unit is matched with the second image in scale. The first feature and the second feature map may reflect the image features of the first image and the second image respectively, for example, the information of the pixel values of the pixels and the like.

The convolutional unit may include at least one convolutional layer, and each convolutional layer may execute a convolution operation by use of a different convolution kernel or may execute the convolution operation by use of the same convolution kernel, and this may be selected independently by those skilled in the art and will not be limited in the disclosure.

In S233, addition processing is performed on the first intermediate feature map of the first image and the first concatenated feature map subjected to convolution processing to obtain the first feature map of the first image, and addition processing is performed on the first intermediate feature map of the second image and the second concatenated feature map subjected to convolution processing to obtain the first feature map of the second image.

Based on a processing result of S232, addition processing, such as addition of corresponding elements, may further be performed on the first intermediate feature map of the first image and the first concatenated feature map subjected to convolution processing to obtain the first feature map of the first image, and correspondingly, addition processing is performed on the first intermediate feature map of the second image and the second concatenated feature map subjected to convolution processing to obtain the first feature map of the second image.

Through the abovementioned configuration, a whole process of the deblurring network module may be implemented, and a process of optimizing and extracting the feature information of the first image and the second image may be implemented. In the embodiments of the disclosure, the multi-branch context-aware unit is introduced, so that rich multiscale features may be acquired without enlarging a network model. The deblurring network model may be designed through small convolution kernels to finally obtain a neural network model occupying a small space and capable of implementing rapid binocular deblurring.

In addition, the first depth maps of the first image and the second image may also be obtained in S20. FIG. 6 is another flowchart of S20 in an image processing method according to embodiments of the disclosure. The operation that the first depth maps of the first image and the second image are acquired may include the following operations.

In S201, the first image and the second image are combined to form a combined view.

In some embodiments of the disclosure, the neural network may further include the depth feature extraction module B (shown in FIG. 3). The depth information, such as the first depth maps, of the first image and the second image may be obtained through the depth feature extraction module. The first depth map may be represented in form of a matrix, and elements in the matrix may represent depth values of the corresponding pixels in the first image or the second image.

At first, the first image and the second image may be combined to form a combined view to be input to the depth feature extraction module. An image combination manner may be directly concatenating the two images in a direction of upper and lower positions. In another embodiment, the two images may also be concatenated in a left-right combination manner No specific limits are made thereto in the disclosure.

In S202, third convolution processing at at least one layer is performed on the combined view to obtain a first intermediate depth feature map.

After the combined view is obtained, convolution processing may be performed on the combined view. Third convolution processing may be performed at least once. Third convolution processing may also involve at least one convolutional unit, and each convolutional unit may execute convolution by use of a third convolution kernel or execute convolution according to a third preset step to finally obtain the first intermediate depth map representing depth information of the combined view. The third convolution kernel may be a 1*1 convolution kernel and may also be a 3*3 convolution kernel, and the third preset step may be 2. Those skill in the art may select and set them according to requirements. No limits are made thereto in the embodiments of the disclosure. The convolution kernel adopted in the embodiment of the disclosure may be a small convolution kernel, so that the structure of the neural network may be simplified, and meanwhile, the requirement on the image processing accuracy may be met.

In S203, fourth convolution processing is performed on the first intermediate depth feature map to obtain second intermediate depth feature maps of multiple scales.

Furthermore, the depth feature extraction module of the embodiments of the disclosure may also include a context-aware unit, configured to extract multiscale features of the first intermediate feature map. That is, after the first intermediate feature map is obtained, second intermediate depth feature maps of different scales may be obtained by use of the context-aware unit. The context-aware unit in the depth feature extraction module may also execute fourth convolution processing on the first intermediate feature map by use of different second atrous rates. For example, in FIG. 4, fourth convolution processing is performed on the first intermediate depth feature map by use of four different second atrous rates d₁, d₂, d₃ and d₄ to obtain four second intermediate depth feature maps of four different scales. For example, the scales of all second intermediate depth feature maps may have a changing relationship of double. No specific limits are made thereto in the disclosure. Those skilled in the art may select different atrous rates according to requirements to execute corresponding fourth convolution processing to obtain corresponding second intermediate depth feature maps. In addition, the number of the atrous rates is also not specifically limited in the disclosure. The first atrous rate and second atrous rate in the embodiments of the disclosure may be the same and may also be different, and no specific limits are made thereto in the disclosure.

That is, in S203, a first intermediate depth feature map of the first image and a first intermediate depth feature map of the second image may be input to the context-aware unit respectively, and atrous convolution processing may be performed on all first intermediate depth feature maps by use of different second atrous rates through the context-aware unit to obtain second intermediate feature maps of multiple scales corresponding to the first intermediate feature map of the first image and second intermediate feature maps of multiple scales corresponding to the first intermediate feature map of the second image.

In S204, residual processing is performed on the second intermediate depth feature and the first intermediate depth feature map to obtain first depth maps of the first image and the second image respectively, and the second feature maps are obtained according to first convolution processing at any one layer.

In some embodiments of the disclosure, based on a processing result of S203, the second intermediate depth feature maps of all scales corresponding to the first image may further be concatenated, for example, concatenated in a channel direction, and then convolution processing is performed on a concatenated depth map obtained by concatenation. Depth features in each second intermediate depth feature map may further be fused through this process, and a scale of the concatenated depth map obtained by convolution processing is the same as a scale of the first intermediate depth feature map of the first image. Correspondingly, the second intermediate depth feature maps of all scales corresponding to the second image may be concatenated, for example, concatenated in the channel direction, and then convolution processing is performed on a concatenated depth map obtained by concatenation. Depth features in each second intermediate depth feature map may further be fused through this process, and a scale of the concatenated depth map obtained by convolution processing is the same as a scale of the first intermediate depth feature map of the second image.

Then, addition processing, such as addition of corresponding elements, may be performed on the feature maps obtained by convolution processing and the corresponding first intermediate depth feature maps, and convolution processing is performed on addition results to obtain the first depth maps of the first image and the second image respectively.

Through the abovementioned configuration, a whole process of the depth feature extraction module may be implemented, and a process of optimizing and extracting the depth information of the first image and the second image may be implemented. In the embodiments of the disclosure, the multi-branch context-aware unit is introduced, so that rich multiscale depth features may be acquired without enlarging the network model, and the characteristics of simple network structure and high running speed are achieved.

It is to be noted herein that the second feature maps including the image information and depth information of the first image and the second image may also be obtained in S20. This process may be implemented based on a processing process of the depth feature extraction module. At least one time of third convolution processing may be performed in the depth feature extraction module, and the depth map fusing the image feature may be obtained based on third convolution processing at at least one layer, so that the second feature map fusing the image feature and depth feature of the first image and the second feature map fusing the image feature and depth feature of the second image may be acquired.

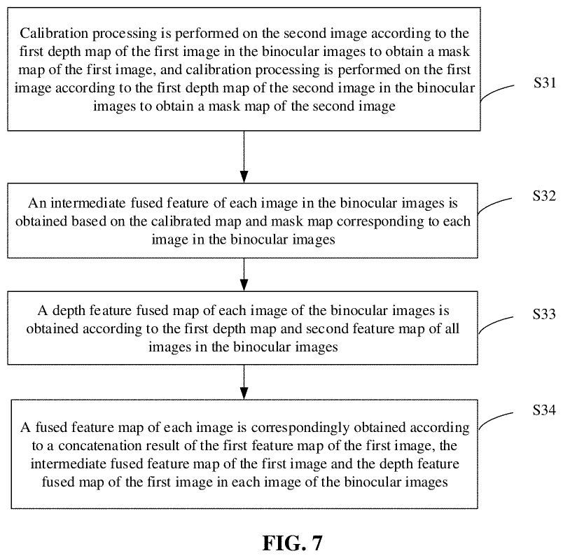

After S20 is executed, feature fusion processing may be performed on each obtained feature. FIG. 7 is a flowchart of S30 in an image processing method according to embodiments of the disclosure. The operation that feature fusion processing is performed on the binocular images, the first feature maps of the binocular images, the first depth maps of the binocular images and the second feature maps to obtain the fused feature map of the binocular images (S30) may include the following operations.

In S31, calibration processing is performed on the second image according to the first depth map of the first image in the binocular images to obtain a mask map of the first image, and calibration processing is performed on the first image according to the first depth map of the second image in the binocular images to obtain a mask map of the second image.

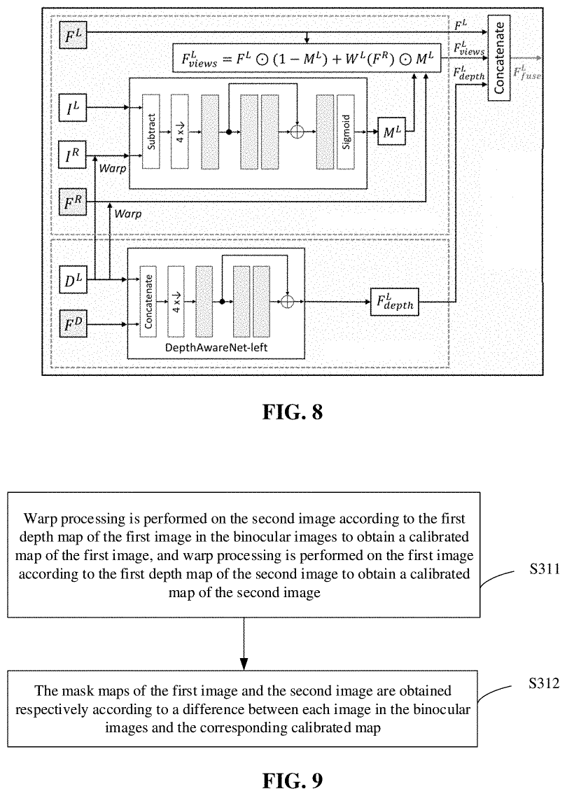

The neural network of the embodiments of the disclosure may further include a fusion network module, configured to perform fusion processing on the feature information. FIG. 8 is a block diagram of a fusion network module according to embodiments of the disclosure. A fused feature map of the first image may be obtained according to a fusion processing result of the first image, the first depth map of the first image, the first feature map of the first image and the second feature map of the first image, and a fused feature map of the second image may be obtained according to a fusion processing result of the second image, the first depth map of the second image, the first feature map of the second image and the second feature map of the second image.

In some embodiments, as mentioned above, the neural network of the disclosure may further include a feature fusion module C, and further fusion and optimization of the feature information may be executed through the feature fusion module C.

In some embodiments of the disclosure, the intermediate feature map of each image in the binocular images may be obtained at first according to a calibrated map and mask map corresponding to each image in the binocular images, namely an intermediate fused feature of the first image is obtained by use of the calibrated map and mask map of the first image, and an intermediate fused feature of the second image is obtained by use of the calibrated map and mask map of the second image. The calibrated map refers to a feature map obtained by calibration processing using the depth information. The mask map represents an admissibility of the feature information in the first feature map of the image. An acquisition process of the calibrated map and the mask map will be described below.

FIG. 9 is a flowchart of S31 in an image processing method according to embodiments of the disclosure. The operation that calibration processing is performed on the second image according to the first depth map of the first image in the binocular images to obtain the mask map of the first image and calibration processing is performed on the first image according to the first depth map of the second image in the binocular images to obtain the mask map of the second image includes the following operations.

In S311, warp processing is performed on the second image according to the first depth map of the first image in the binocular images to obtain a calibrated map of the first image, and warp processing is performed on the first image according to the first depth map of the second image to obtain a calibrated map of the second image.

In some embodiments of the disclosure, warp processing may be performed on the second image by use of the depth feature of the first image to obtain the calibrated map of the first image, and warp processing may be performed on the second image by use of the depth feature of the second image to obtain the calibrated map of the second image.

A process of performing warp processing may be implemented in the following manner:

first depth feature=baseline*focal length/pixel offset feature.

The baseline represents a distance between two lenses acquiring the first image and the second image, and the focal length refers to focal lengths of the two lenses. In such a manner, a first pixel offset feature corresponding to the first depth map may be determined according to the first depth map of the first image, and a second pixel offset feature corresponding to the first depth map may be determined according to the first depth map of the second image. Herein, the pixel offset feature refers to a deviation of a pixel value corresponding to a depth feature of each pixel in the first depth map. In the embodiments of the disclosure, warp processing may be performed on the image by use of the deviation, namely the first pixel offset feature corresponding to the first depth feature of the first image acts on the second image to obtain the calibrated map of the first image, and the second pixel offset feature corresponding to the first depth map of the second image acts on the first image to obtain the calibrated map of the second image.

After a first pixel offset corresponding to the first depth map of the first image is obtained, warp processing may be performed on the second image according to the first pixel offset. That is, the pixel feature of the second image and the first pixel offset are added to obtain the calibrated map of the first image. Warp processing is performed on the first image according to a second pixel offset, namely the corresponding pixel feature of the first image and the second pixel offset are added to obtain the calibrated map of the first image.

In S312, the mask maps of the first image and the second image are obtained according to a difference between each image in the binocular images and the corresponding calibrated map respectively.

After the calibrated map of each image is obtained, difference processing may be performed on each image and the corresponding calibrated map, and the mask map may be obtained by a difference processing result.

A difference value between the first image and the calibrated map of the first image may be represented as ΔI^{L}=|I^{L}−W^{L}(I^{R})| and a difference value between the second image and the calibrated map of the second image may be represented as ΔI^{R}=|I^{R}−W^{R}(I^{L})|, where ΔI^{L} is a calibrated map of a first difference value between the first image and the calibrated map of the first image, I^{L} represents the first image, W^{L}(I^{R}) represents the calibrated map obtained after warp processing is performed on the second image by use of the first depth map of the first image, ΔI^{R} represents a second difference value between the second image and the calibrated map of the second image, I^{R} represents the second image, and W^{R}(I^{L}) represents the calibrated map obtained by use of the second image.

Through the abovementioned process, the difference value between the first image and the calibrated map of the first image, for example, the first difference value and the second difference value, may be obtained. The first difference value and the second difference value may be represented in the matrix form and may represent the deviations of each pixel of the first image and the second image. In such case, an optimization operation may be executed on the difference value through a mask network module in the feature fusion module, and admissibility matrices corresponding to the feature information of the first image and the second image, i.e., the corresponding mask maps, are output.

The mask map of the first image may be obtained based on the first difference value between the first image and the calibrated map of the first image, and the mask map of the second image may be obtained based on the second difference value between the second image and the calibrated map of the second image. The mask map of the first image represents the admissibility of the feature information in the first feature map of the first image, and the mask map of the second image represents the admissibility of the feature information in the first feature map of the second image.

As shown in FIG. 8, convolution processing may be performed on the first difference value between the first image and the calibrated map thereof, for example, convolution processing is performed twice, a result after the convolution processing and the original first difference value are added, and then convolution processing is performed again to finally output the admissibility matrix (mask map) corresponding to the feature information of the first image, the admissibility matrix representing an admissibility of first feature information of each pixel of the first image. In addition, convolution processing may be performed on the second difference value between the second image and the calibrated map thereof, for example, convolution processing is performed twice, a result after the convolution processing and the original difference value are added, and then convolution processing is performed again to finally output the admissibility matrix (mask map) corresponding to the feature information of the second image, the admissibility matrix representing an admissibility of first feature information of each pixel of the second image. The admissibility may be any numerical value between 0 and 1. According to different designs or model training manners, if the numerical value is greater, the admissibility is higher, or if the numerical value is smaller, the admissibility is higher. No specific limits are made thereto in the disclosure.

In S32, an intermediate fused feature of each image in the binocular images is obtained based on the calibrated map and mask map corresponding to each image in the binocular images.

In some embodiments of the disclosure, feature fusion may further be performed by use of the obtained information such as the calibrated map, the mask map and the binocular images to obtain an intermediate fused feature map.

In some embodiments, an intermediate fused feature map of the first image may be obtained in a first preset manner according to the calibrated map of the first image and the mask map of the first image, and an intermediate fused feature map of the second image may be obtained in a second preset manner based on the calibrated map of the second image and the mask map of the second image. An expression of the first preset manner is:

F_{views}^{L}=F^{L}⊙(1−M^{L})+W^{L}(F^{R})⊙M^{L}.

F_{views}^{L} represents an intermediate fused feature of the first image, ⊙ represents multiplication of corresponding elements, W^{L}(I^{R}) represents the calibrated map obtained after warp processing is performed on the second image by use of the first depth map of the first image, and M^{L} represents the mask map of the first image.

An expression of the second preset manner is:

$${F}_{v i e w s}^{R} = {F}^{R} ⊙ ( 1 - {M}^{R} ) + {W}^{R} ( {F}^{L} ) ⊙ {M}^{R} .$$

F_{views}^{R} represents an intermediate fused feature of the second image, ⊙ represents multiplication of corresponding elements, W^{R}(F^{L}) represents the calibrated map obtained after warping processing is performed on the first image by use of the first depth map of the second image, and M^{R} represents the mask map of the second image.

In S33, a depth feature fused map of each image of the binocular images is obtained according to the first depth map and second feature map of each image in the binocular images.

Furthermore, in the embodiments of the disclosure, a feature fusion process for the first depth maps of the two images may further be executed. The depth feature fused map of the first image may be obtained according to the first depth map of the first image and the second feature map of the first image, namely at least one time of convolution processing is performed on the second feature map, including the image information and the feature information, of the first image and the first depth map to further fuse each piece of depth information and view information to obtain the depth feature fused map.

Correspondingly, the depth feature fused map of the second image may be obtained by use of the first depth map of the second image and the second feature map of the second image, namely at least one time of convolution processing may be performed on the second feature map, including the view information and the feature information, of the second image and the first depth map to further fuse each piece of depth information and view information to obtain the depth feature fused map.

In S34, a fused feature map of each image is correspondingly obtained according to a concatenation result of the first feature map of the first image, the intermediate fused feature map of the first image and the depth feature fused map of the first image in each image of the binocular images.

The fused feature map of the first image may be obtained according to the concatenation result of the first feature map of the first image, the intermediate fused feature map of the first image and the depth feature fused map of the first image, and a fused feature map of the second image may be obtained according to a concatenation result of the first feature map of the second image, the intermediate fused feature map of the second image and the depth feature fused map of the second image.

In some embodiments of the disclosure, after each first feature map, intermediate fused feature map and depth feature fused map are obtained, the information may be concatenated, for example, concatenated in the channel direction, to obtain the fused feature map of the corresponding view.

The fused feature map obtained in such a manner includes optimized depth information and view information and the intermediate fused feature fusing the depth information and the view information. Correspondingly, in S40, convolution processing may further be performed on the fused feature map to obtain corresponding optimized binocular images of the binocular images. The operation that optimization processing is performed on the fused feature map of the binocular images to obtain the deblurred binocular images includes the following operation.

Convolution processing is performed on the fused feature map of the first image to obtain an optimized first image, and convolution processing is performed on the fused feature map of the second image to obtain an optimized second image.

Through S40, an optimized image matched with the scale of the original binocular images may be obtained on one hand; and on the other hand, each feature may be fused deeply, and the accuracy of the information may be improved.

Reasons for image blurring are very complicated, for example, camera jitter, defocusing and high-speed movement of an object, and an existing image edition tool is unlikely to restore such a complicated blurry image.

In some embodiments of the disclosure, the foregoing technical problems are solved, and the embodiments may be applied to photographing through a binocular smart phone. Through the method, image blurring caused by jitter or high-speed movement may be eliminated, a clear image may be obtained, and better photographing experiences may be provided for a user. In addition, the embodiments of the disclosure may also be applied to a vision system of an air vehicle, a robot or automatic driving, image blurring caused by jitter or high-speed movement may be recovered, and an obtained clear image helps another vision system to achieve higher performance, for example, an obstacle avoidance system and a Simultaneous Localization and Mapping (SLAM) reconstruction system.

The method of the embodiments of the disclosure may also be applied to video monitoring aided analysis of vehicles. Through the method, the performance of recovering blurring caused by high-speed movement may be greatly improved, and information of a vehicle running at a high speed, for example, number plate and driver appearance information, may be captured more clearly.

To sum up, according to the embodiments of the disclosure, the binocular images are taken as an input, feature extraction processing may be performed on the first image and second image in the binocular images to obtain the corresponding first feature maps respectively, the depth maps of the first image and the second image may be obtained, then the first feature and depth value of the binocular images are fused to obtain a feature including the image information and depth information of the first image and the second image, the feature including richer picture information and being higher in robustness to space-variant blur, and finally, optimization processing of deblurring processing is performed on the fused feature to obtain clear binocular images.

It can be understood by those skilled in the art that, in the method of the specific implementation modes, the writing sequence of each step does not mean a strict execution sequence and is not intended to form any limit to the implementation process and a specific execution sequence of each step should be determined by functions and probable internal logic thereof.

It can be understood that each method embodiment mentioned in the disclosure may be combined to form combined embodiments without departing from principles and logics. For saving the space, elaborations are omitted in the disclosure.

In addition, the disclosure also provides an image processing device, an electronic device, a computer-readable storage medium and a program. All of them may be configured to implement any image processing method provided in the disclosure. Corresponding technical solutions and descriptions refer to the corresponding records in the method part and will not be elaborated.

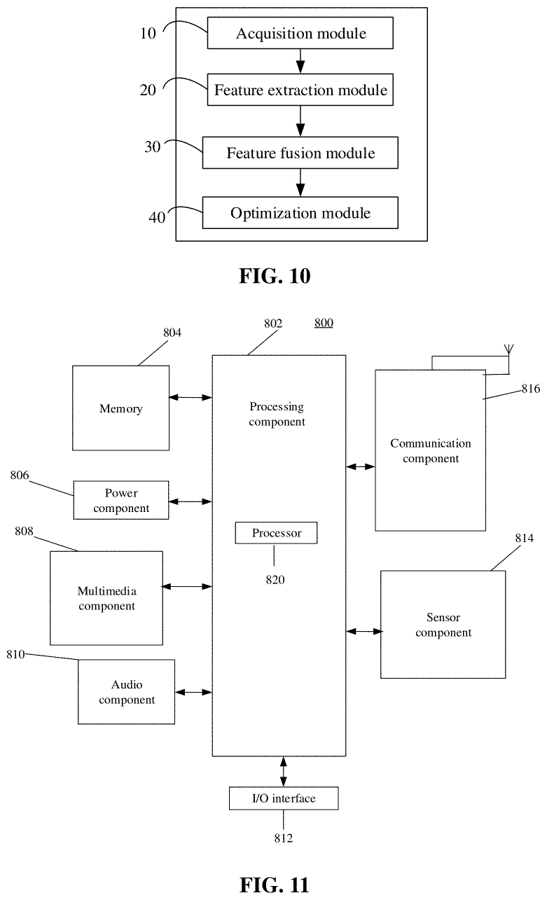

FIG. 10 is a block diagram of an image processing device according to an embodiment of the disclosure. As shown in FIG. 10, the image processing device includes: an acquisition module 10, configured to acquire a binocular images, the binocular images including a first image and second image which are shot for the same object in the same scenario; a feature extraction module 20, configured to obtain first feature maps of the binocular images, first depth maps of the binocular images and second feature maps fusing an image feature and depth feature of the binocular images; a feature fusion module 30, configured to perform feature fusion processing on the binocular images, the first feature maps of the binocular images, the first depth maps and the second feature maps to obtain fused feature maps of the binocular images; and an optimization module 40, configured to perform optimization processing on the fused feature maps of the binocular images to obtain deblurred binocular images.

In some examples, the feature extraction module includes an image feature extraction module, configured to perform first convolution processing on the first image and the second image respectively to obtain first intermediate feature maps respectively corresponding to the first image and the second image, perform second convolution processing on the first intermediate feature maps of the first image and the second image respectively to obtain second intermediate feature maps of multiple scales respectively corresponding to the first image and the second image and perform residual processing on the second intermediate feature maps of each scale of the first image and the second image respectively to obtain first feature maps respectively corresponding to the first image and the second image.

In some examples, the image feature extraction module is further configured to perform convolution processing on the first image and the second image respectively by use of a first preset convolution kernel and a first convolution step to obtain the first intermediate feature maps respectively corresponding to the first image and the second image.

In some examples, the image feature extraction module is further configured to perform convolution processing on the first intermediate feature maps of the first image and the second image according to preset multiple different first atrous rates respectively to obtain second intermediate feature maps respectively corresponding to the multiple first atrous rates.

In some examples, the image feature extraction module is further configured to concatenate the second intermediate feature maps of the multiple scales corresponding to the first image respectively to obtain a first concatenated feature map, concatenate the second intermediate feature maps of the multiple scales corresponding to the second image respectively to obtain a second concatenated feature map, perform convolution processing on the first concatenated feature map and the second concatenated feature map respectively, perform addition processing on the first intermediate feature map of the first image and the first concatenated feature map subjected to convolution processing to obtain the first feature map of the first image and perform addition processing on the first intermediate feature map of the second image and the second concatenated feature map subjected to convolution processing to obtain the first feature map of the second image.

In some examples, the feature extraction module further includes a depth feature extraction module, configured to combine the first image and the second image to form a combined view, perform, on the combined view, third convolution processing at at least one layer to obtain a first intermediate depth feature map, perform fourth convolution processing on the first intermediate depth feature map to obtain second intermediate depth feature maps of multiple scales, perform residual processing on the second intermediate depth feature and the first intermediate depth feature map to obtain first depth maps of the first image and the second image respectively and obtain the second feature maps according to third convolution processing at any one layer.

In some examples, the depth feature extraction module is further configured to perform, on the combined view, at least one time of convolution processing on the combined view by use of a second preset convolution kernel and a second convolution step to obtain the first intermediate depth feature map.

In some examples, the depth feature extraction module is further configured to perform convolution processing on the first intermediate depth feature map according to preset multiple different second atrous rates respectively to obtain second intermediate feature maps respectively corresponding to the multiple second atrous rates.

In some examples, the feature fusion module is further configured to perform calibration processing on the second image according to the first depth map of the first image in the binocular images to obtain a mask map of the first image, perform calibration processing on the first image according to the first depth map of the second image in the binocular images to obtain a mask map of the second image, obtain an intermediate fused feature of each image in the binocular images based on the calibrated map and mask map corresponding to each image in the binocular images, obtain a depth feature fused map of each image of the binocular images according to the first depth map and second feature map of each image in the binocular images and correspondingly obtain a fused feature map of each image according to a concatenation result of the first feature map of the first image, an intermediate fused feature map of the first image and the depth feature fused map of the first image in all images of the binocular images.

In some examples, the feature fusion module is further configured to perform warp processing on the second image by use of the first depth map of the first image in the binocular images to obtain a calibrated map of the first image, perform warp processing on the first image by use of the first depth map of the second image to obtain a calibrated map of the second image and obtain the mask maps of the first image and the second image respectively according to a difference between each image in the binocular images and the corresponding calibrated map.

In some examples, the feature fusion module is further configured to obtain the intermediate fused feature map of the first image in a first preset manner based on the calibrated map of the first image and the mask map of the first image and obtain an intermediate fused feature map of the second image in a second preset manner based on the calibrated map of the second image and the mask map of the second image.

In some examples, an expression of the first preset manner is:

F_{views}^{L}=F^{L}⊙(1−M^{L})+W^{L}(F^{R})⊙M^{L}, where F_{views}^{L} represents an intermediate fused feature of the first image, ⊙ represents multiplication of corresponding elements, W^{L}(I^{R}) represents a result obtained after the second image is processed by use of the first depth map of the first image, and M^{L} represents the mask map of the first image.

An expression of the second preset manner is: F_{views}^{R}=F^{R}⊙(1−M^{R})+W^{R}(F^{L})⊙M^{R}.

F_{views}^{R} represents an intermediate fused feature of the second image, ⊙ represents multiplication of corresponding elements, W^{R}(F^{L}) represents a result obtained after warp processing is performed on the first image by use of the first depth map of the second image, and M^{R} represents the mask map of the second image.

In some examples, the optimization module is further configured to perform convolution processing on the fused feature maps of the binocular images to obtain the deblurred binocular images.

In some embodiments, functions or modules of the device provided in the embodiments of the disclosure may be configured to execute the method described in the method embodiment and specific implementation thereof may refer to the descriptions about the method embodiment and, for simplicity, will not be elaborated herein.

The embodiments of the disclosure also disclose a computer-readable storage medium, in which computer program instructions are stored, the computer program instructions being executed by a processor to implement the method. The computer-readable storage medium may be a nonvolatile computer-readable storage medium.

The embodiments of the disclosure disclose an electronic device, which includes a processor and a memory configured to store instructions executable for the processor, the processor being configured for the method. The electronic device may be provided as a terminal, a server or a device in another form.

The embodiments of the application disclose a computer program product, which includes computer program instructions, the computer program instructions being executed by a processor to implement any abovementioned method.

FIG. 11 is a block diagram of an electronic device 800 according to embodiments of the disclosure. For example, the electronic device 800 may be a terminal such as a mobile phone, a computer, a digital broadcast terminal, a messaging device, a gaming console, a tablet, a medical device, exercise equipment and a personal digital assistant. Referring to FIG. 11, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the abovementioned method. Moreover, the processing component 802 may include one or more modules which facilitate interaction between the processing component 802 and the other components. For instance, the processing component 802 may include a multimedia module to facilitate interaction between the multimedia component 808 and the processing component 802.

The memory 804 is configured to store various types of data to support the operation of the electronic device 800. Examples of such data include instructions for any application programs or methods operated on the electronic device 800, contact data, phonebook data, messages, pictures, video, etc. The memory 804 may be implemented by a volatile or nonvolatile storage device of any type or a combination thereof, for example, a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power component 806 provides power for various components of the electronic device 800. The power component 806 may include a power management system, one or more power supplies, and other components associated with generation, management and distribution of power for the electronic device 800.

The multimedia component 808 includes a screen providing an output interface between the electronic device 800 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. The touch sensors may not only sense a boundary of a touch or swipe action but also detect a duration and pressure associated with the touch or swipe action. The front camera and/or the rear camera may receive external multimedia data when the electronic device 800 is in an operation mode, such as a photographing mode or a video mode. Each of the front camera and the rear camera may be a fixed optical lens system or have focusing and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal may further be stored in the memory 804 or sent through the communication component 816. In some embodiments, the audio component 810 further includes a speaker configured to output the audio signal.

The I/O interface 812 provides an interface between the processing component 802 and a peripheral interface module, and the peripheral interface module may be a keyboard, a click wheel, a button and the like. The button may include, but not limited to: a home button, a volume button, a starting button and a locking button.

The sensor component 814 includes one or more sensors configured to provide status assessment in various aspects for the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor configured to detect presence of an object nearby without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In an exemplary embodiment, the communication component 816 receives a broadcast signal or broadcast associated information from an external broadcast management system through a broadcast channel In an exemplary embodiment, the communication component 816 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Bluetooth (BT) technology and another technology.

In the exemplary embodiment, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In the exemplary embodiment, a nonvolatile computer-readable storage medium is also provided, for example, a memory 804 including a computer program instruction. The computer program instruction may be executed by a processor 820 of an electronic device 800 to implement the abovementioned method.

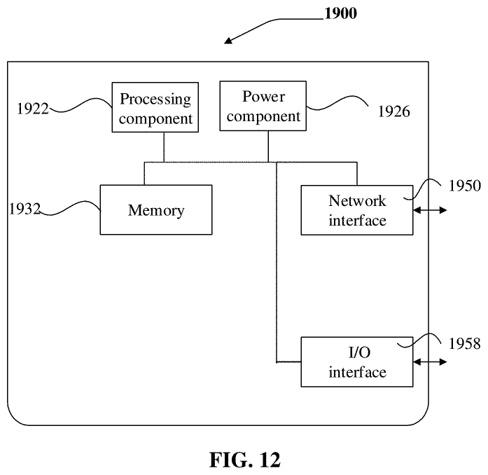

FIG. 12 is a block diagram of an electronic device 1900 according to embodiments of the disclosure. For example, the electronic device 1900 may be provided as a server. Referring to FIG. 12, the electronic device 1900 includes a processing component 1922, further including one or more processors, and a memory resource represented by a memory 1932, configured to store an instruction executable for the processing component 1922, for example, an application program. The application program stored in the memory 1932 may include one or more than one module of which each corresponds to a set of instructions. In addition, the processing component 1922 is configured to execute the instruction to execute the abovementioned method.

The electronic device 1900 may further include a power component 1926 configured to execute power management of the electronic device 1900, a wired or wireless network interface 1950 configured to concatenate the electronic device 1900 to a network and an I/O interface 1958. The electronic device 1900 may be operated based on an operating system stored in the memory 1932, for example, Windows Server™, Mac OS X™, Unix™, Linux™, FreeBSD™ or the like.

In the exemplary embodiment, a nonvolatile computer-readable storage medium is also provided, for example, a memory 1932 including a computer program instruction. The computer program instruction may be executed by a processing component 1922 of an electronic device 1900 to implement the abovementioned method.

The disclosure may be a system, a method and/or a computer program product. The computer program product may include a computer-readable storage medium, in which computer-readable program instructions configured to enable a processor to implement each aspect of the disclosure is stored.

The computer-readable storage medium may be a physical device capable of retaining and storing an instruction used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical encoding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely executed in a computer of a user or partially executed in the computer of the user, executed as an independent software package, executed partially in the computer of the user and partially in a remote computer, or executed completely in the remote server or a server. Under the condition that the remote computer is involved, the remote computer may be concatenated to the computer of the user through any type of network including an LAN or a WAN, or, may be concatenated to an external computer (for example, concatenated by an Internet service provider through the Internet). In some embodiments, an electronic circuit such as a programmable logic circuit, an FPGA or a Programmable Logic Array (PLA) may be customized by use of state information of a computer-readable program instruction, and the electronic circuit may execute the computer-readable program instruction, thereby implementing each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or improvements in the technologies in the market best or enable others of ordinary skill in the art to understand each embodiment disclosed herein.

1. An image processing method, comprising:
acquiring binocular images, the binocular images comprising a first image and second image which are shot for the same object in the same scenario;
obtaining first feature maps of the binocular images, first depth maps of the binocular images and second feature maps fusing an image feature and depth feature of the binocular images;
performing feature fusion processing on the binocular images, the first feature maps of the binocular images, the first depth maps of the binocular images and the second feature maps to obtain fused feature maps of the binocular images; and
performing optimization processing on the fused feature maps of the binocular images to obtain deblurred binocular images.

2. The method of claim 1, wherein obtaining the first feature maps of the binocular images comprises:
performing first convolution processing on the first image and the second image respectively to obtain first intermediate feature maps respectively corresponding to the first image and the second image;
performing second convolution processing on the first intermediate feature maps of the first image and the second image respectively to obtain second intermediate feature maps of multiple scales respectively corresponding to the first image and the second image; and
performing residual processing on the second intermediate feature maps of each scale of the first image and the second image respectively to obtain first feature maps respectively corresponding to the first image and the second image.

3. The method of claim 2, wherein performing first convolution processing on the first image and second image respectively to obtain the first intermediate feature maps respectively corresponding to the first image and the second image comprises:
performing convolution processing on the first image and the second image respectively by use of a first preset convolution kernel and a first convolution step to obtain the first intermediate feature maps respectively corresponding to the first image and the second image.

4. The method of claim 2, wherein performing second convolution processing on the first intermediate feature maps of the first image and the second image respectively to obtain the second intermediate feature maps of the multiple scales respectively corresponding to the first image and the second image comprises:
performing convolution processing on the first intermediate feature maps of the first image and the second image according to preset multiple different first atrous rates respectively to obtain second intermediate feature maps respectively corresponding to the preset multiple different first atrous rates.

5. The method of claim 2, wherein performing residual processing on the second intermediate feature maps of each scale of the first image and the second image respectively to obtain the first feature maps respectively corresponding to the first image and the second image comprises:
concatenating second intermediate feature maps of the multiple scales of the first image respectively to obtain a first concatenated feature map, and concatenating second intermediate feature maps of the multiple scales of the second image respectively to obtain a second concatenated feature map;
performing convolution processing on the first concatenated feature map and the second concatenated feature map respectively; and
performing addition processing on a first intermediate feature map of the first image and the first concatenated feature map subjected to convolution processing to obtain a first feature map of the first image, and performing addition processing on a first intermediate feature map of the second image and the second concatenated feature map subjected to convolution processing to obtain a first feature map of the second image.

6. The method of claim 1, wherein obtaining the first depth maps of the binocular images and the second feature maps fusing the image feature and depth feature of the binocular images comprises:
combining the first image and the second image to form a combined view;
performing, on the combined view, third convolution processing at at least one layer to obtain a first intermediate depth feature map;
performing fourth convolution processing on the first intermediate depth feature map to obtain second intermediate depth feature maps of multiple scales; and
performing residual processing on the second intermediate depth feature and the first intermediate depth feature map to obtain first depth maps of the first image and the second image respectively, and obtaining the second feature maps according to third convolution processing at any one layer.

7. The method of claim 6, wherein performing, on the combined view, third convolution processing at the at least one layer to obtain the first intermediate depth feature map comprises:
performing, on the combined view, at least one time of convolution processing by use of a second preset convolution kernel and a second convolution step to obtain the first intermediate depth feature map.

8. The method of claim 6, wherein performing fourth convolution processing on the first intermediate depth feature map to obtain the second intermediate depth feature maps of the multiple scales comprises:
performing convolution processing on the first intermediate depth feature map according to preset multiple different second atrous rates respectively to obtain second intermediate feature maps respectively corresponding to the preset multiple different second atrous rates.

9. The method of claim 1, wherein performing feature fusion processing on the binocular images, the first feature maps of the binocular images, the first depth maps of the binocular images and the second feature maps to obtain the fused feature maps of the binocular images comprises:
performing calibration processing on the second image according to a first depth map of the first image in the binocular images to obtain a mask map of the first image, and performing calibration processing on the first image according to a first depth map of the second image in the binocular images to obtain a mask map of the second image;
obtaining an intermediate fused feature of each image in the binocular images based on a calibrated map and the mask map corresponding to each image in the binocular images;
obtaining a depth feature fused map of each image of the binocular images according to a first depth map and second feature map of each image in the binocular images; and
correspondingly obtaining a fused feature map of each image according to a concatenation result of the first feature map of the first image, an intermediate fused feature map of the first image and the depth feature fused map of the first image in all images of the binocular images.

10. The method of claim 9, wherein performing calibration processing on the second image according to the first depth map of the first image in the binocular images to obtain the mask map of the first image and performing calibration processing on the first image according to the first depth map of the second image in the binocular images to obtain the mask map of the second image comprises:
performing warp processing on the second image by use of the first depth map of the first image in the binocular images to obtain a calibrated map of the first image, and performing warp processing on the first image by use of the first depth map of the second image to obtain a calibrated map of the second image; and
obtaining the mask maps of the first image and the second image respectively according to a difference between each image in the binocular images and a corresponding calibrated map.

11. The method of claim 9, wherein obtaining the intermediate fused feature of each image in the binocular images based on a calibrated map and the mask map corresponding to each image in the binocular images comprises:
obtaining the intermediate fused feature map of the first image in a first preset manner based on a calibrated map of the first image and the mask map of the first image; and
obtaining an intermediate fused feature map of the second image in a second preset manner based on a calibrated map of the second image and the mask map of the second image.

12. The method of claim 11, wherein an expression of the first preset manner is:
F_{views}^{L}=F^{L}⊙(1−M^{L})+W^{L}(F^{R})⊙M^{L}, where F_{views}^{L} represents an intermediate fused feature of the first image, ⊙ represents multiplication of corresponding elements, W^{L}(I^{R}) represents a result obtained after the second image is processed by use of the first depth map of the first image, and M^{L} represents the mask map of the first image; and
an expression of the second preset manner is: F_{views}^{R}=F^{R}⊙(1−M^{R})+W^{R}(F^{L})⊙M^{R}, where F_{views}^{R} represents an intermediate fused feature of the second image, ⊙ represents multiplication of corresponding elements, W^{R}(F^{L}) represents a result obtained after warp processing is performed on the first image by use of the first depth map of the second image, and M^{R} represents the mask map of the second image.

13. The method of claim 1, wherein performing optimization processing on the fused feature maps of the binocular images to obtain the deblurred binocular images comprises:
performing convolution processing on the fused feature maps of the binocular images to obtain the deblurred binocular images.

14. An electronic device, comprising:
a processor; and
a memory, configured to store instructions executable for the processor.
wherein the processor is configured to:
acquire binocular images, the binocular images comprising a first image and second image which are shot for the same object in the same scenario;
obtain first feature maps of the binocular images, first depth maps of the binocular images and second feature maps fusing an image feature and depth feature of the binocular images;
perform feature fusion processing on the binocular images, the first feature maps of the binocular images, the first depth maps of the binocular images and the second feature maps to obtain fused feature maps of the binocular images; and
perform optimization processing on the fused feature maps of the binocular images to obtain deblurred binocular images.

15. The electronic device of claim 14, wherein the processor is further configured to:
perform first convolution processing on the first image and second image of the binocular images respectively to obtain first intermediate feature maps respectively corresponding to the first image and the second image;
perform second convolution processing on the first intermediate feature maps of the first image and the second image respectively to obtain second intermediate feature maps of multiple scales respectively corresponding to the first image and the second image; and
perform residual processing on the second intermediate feature maps of each scale of the first image and the second image respectively to obtain first feature maps respectively corresponding to the first image and the second image.

16. The electronic device of claim 15, wherein the processor is further configured to perform convolution processing on the first image and the second image respectively by use of a first preset convolution kernel and a first convolution step to obtain the first intermediate feature maps respectively corresponding to the first image and the second image.

17. The electronic device of claim 15, wherein the processor is further configured to perform convolution processing on the first intermediate feature maps of the first image and the second image according to preset multiple different first atrous rates respectively to obtain second intermediate feature maps respectively corresponding to the preset multiple different first atrous rates.

18. The electronic device of claim 15, wherein the processor is further configured to:
concatenate second intermediate feature maps of the multiple scales of the first image respectively to obtain a first concatenated feature map, concatenate second intermediate feature maps of the multiple scales of the second image respectively to obtain a second concatenated feature map;
perform convolution processing on the first concatenated feature map and the second concatenated feature map respectively; and
perform addition processing on a first intermediate feature map of the first image and the first concatenated feature map subjected to convolution processing to obtain a first feature map of the first image and perform addition processing on a first intermediate feature map of the second image and the second concatenated feature map subjected to convolution processing to obtain a first feature map of the second image.

19. The electronic device of claim 14, wherein the processor is further configured to:
combine the first image and the second image to form a combined view;
perform, on the combined view, third convolution processing at at least one layer to obtain a first intermediate depth feature map;
perform fourth convolution processing on the first intermediate depth feature map to obtain second intermediate depth feature maps of multiple scales; and
perform residual processing on the second intermediate depth feature and the first intermediate depth feature map to obtain first depth maps of the first image and the second image respectively and obtain the second feature maps according to third convolution processing at any one layer.

20. A computer-readable storage medium, in which computer program instructions are stored, the computer program instructions being executed by a processor to perform:
acquiring binocular images, the binocular images comprising a first image and second image which are shot for the same object in the same scenario;
obtaining first feature maps of the binocular images, first depth maps of the binocular images and second feature maps fusing an image feature and depth feature of the binocular images;
performing feature fusion processing on the binocular images, the first feature maps of the binocular images, the first depth maps of the binocular images and the second feature maps to obtain fused feature maps of the binocular images; and
performing optimization processing on the fused feature maps of the binocular images to obtain deblurred binocular images.
